(19) United States
(12) Patent Application Publication
(10) Pub. No.: US 2019/0051106 A1
(43) Pub. Date: Feb. 14, 2019

(54) CHIP MANAGEMENT SYSTEM

(71) Applicants: Venkat Kalyan Chivukula, Katy, TX (US); Anil Tammala, Katy, TX (US)

(72) Inventors: Venkat Kalyan Chivukula, Katy, TX (US); Anil Tammala, Katy, TX (US)

(21) Appl. No.: 16/059,835

(22) Filed: Aug. 9, 2018

Related U.S. Application Data
(60) Provisional application No. 62/543,043, filed on Aug. 9, 2017.

(51) Int. Cl. G07F 17/32

(52) U.S. Cl. CPC G07F 17/3251; G07F 17/3248

(57) ABSTRACT

A chip management system that enables the dynamic display of the value of a players chips. A holding device made of multiple chip modules each with a sensor to measure the chips placed in the device and transmit that data to an application. The application uses the data to determine the value of the chips and transmit that value to a display device to be viewed.

### BACKGROUND

### 1. Field of the Invention

The present invention relates generally to card games and more specifically, to a chip management system for counting and reporting the value of a players gaming tokens or a set of tokens.

### 2. Description of Related Art

Card games are well known in the art and are effective means to facilitate games of chance where wagers are placed. For example, FIG. 1 depicts a conventional chip container device 101 having a frame 103 with a series of cylindrical or semi-cylindrical slots 105. During use, chips 107 of a single denomination are placed in each slot 105 and so facilitates the use and counting of the chips 107 and their respective value.

One of the problems commonly associated with system 101 is its limited use. For example, the container 101 does not count the number of chips 107 in each slot 105 requiring a player to count then calculate the value of the chips 107.

Additionally, it is common to keep the chips on the table in stacks or piles that must then be counted by the player so that the container 101 is not used during game play.

Accordingly, although great strides have been made in the area of chip container devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a common chip container device;

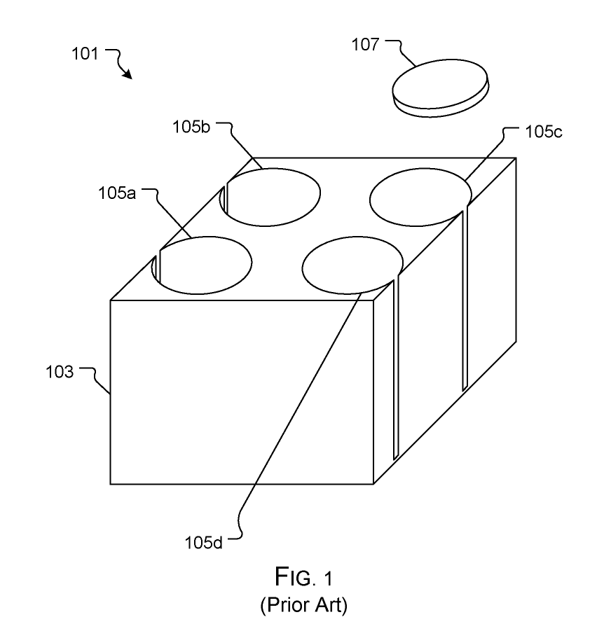

FIG. 2 is a simplified schematic of a chip management system in accordance with a preferred embodiment of the present application;

FIG. 3 is a cross-sectional front view of the holder of the system of FIG. 2;

FIG. 4 is a flowchart of the preferred method of use of the system of FIG. 2; and

FIG. 5 is an alternative embodiment of the holder of FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional chip container devices. Specifically, the invention of the present application facilitates the counting and reporting of the value of a players chips. In addition, the system of the present invention facilitates the counting of chips during and after play. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

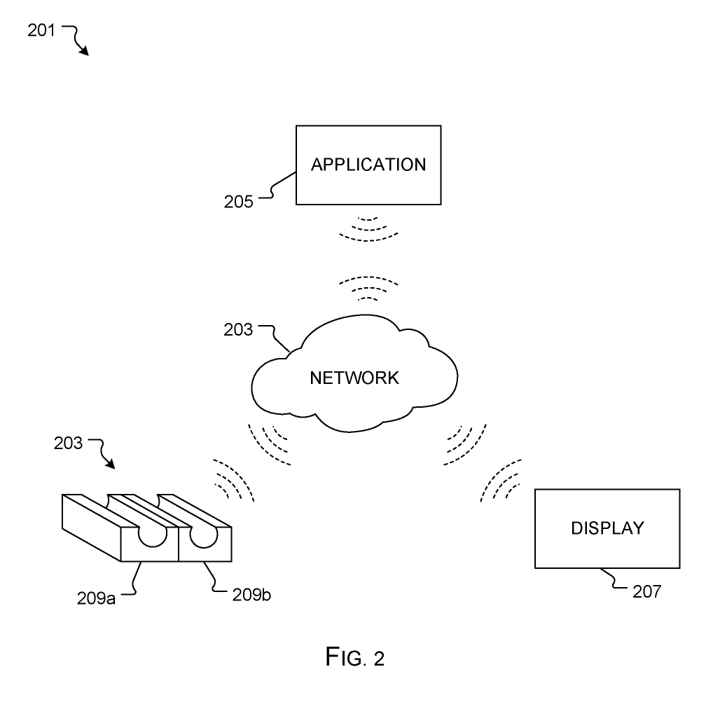

Referring now to the drawings wherein like reference characters identify corresponding or similar elements throughout the several views, FIG. 2 depicts a simplified schematic of a chip management system 201 in accordance with a preferred embodiment of the present application. It will be appreciated that system 201 overcomes one or more of the above-listed problems commonly associated with conventional chip container devices.

In the contemplated embodiment, system 201 includes a holding device 203 in electronic communication with an application 205 via a network 211 wherein the quantity of chips 107 in the holding device 203 is transmitted to the application 205. The application 205 is also in electronic communication with a display device 207 via the network 211.

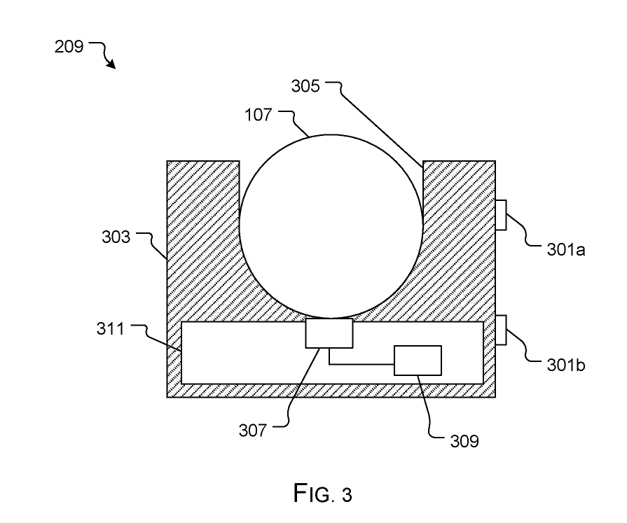

The holding device 203 including a plurality of chip modules 209. A chip module 209 is depicted in FIG. 3. The modules 209 are configured to temporarily attach to each other via connectors 301. The chip modules 209 having a body 303 with a trough 305 disposed therein from the top surface. The trough 305 having a sensor 307 in electronic communication with a transmitter 309. The sensor 307 and transmitter 309 housed in a compartment 311 within the body 305. The sensor 307 of the present application detects the weight of the chips 107 in the trough 305. While a weight sensor has been depicted any other sensor is contemplated.

In use, a player places their chips by denomination in the chip modules 209. As the chips 107 are removed or added the sensor 307 detects the measurement of the chips 107. The data from the sensors 307 is sent via the transmitters 309 to the application 205 where the data is manipulated to find the value of the chips in the holding device. The value is transmitted to the display 207 where it is viewable by the player or others.

It should be appreciated that one of the unique features believed characteristic of the present application is that sensor 309 and application 205 enable the quantification of the value of a players chips 107 dynamically during game play. It will be appreciated that displaying the value of players' chips 107 is of value to the players and the observers.

Another unique feature believed characteristic of the present application is that the sensor 307 calculates the quantity of chips in the module 209 without respect to the fashion or manner in which the chips 107 are placed in the trough 305.

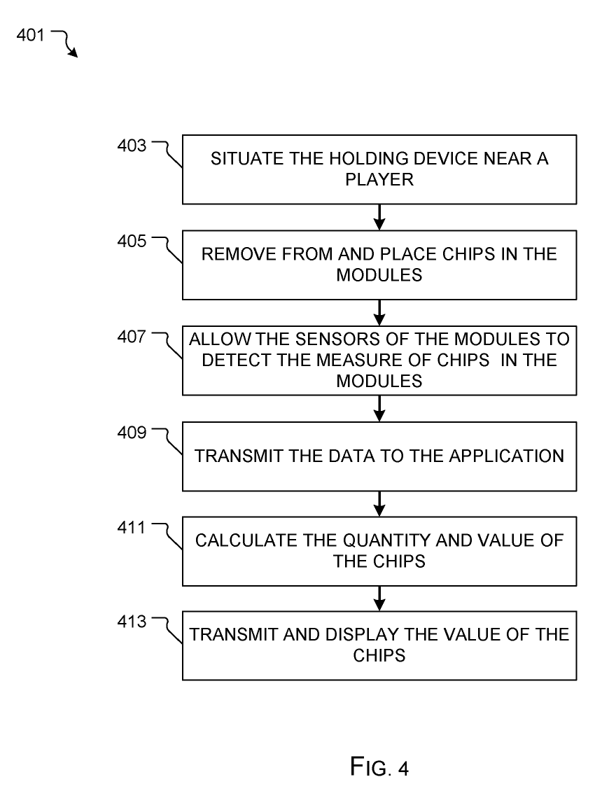

Referring now to FIG. 4 the preferred method of use of the system 201 is depicted. Method 401 including situating the holding device near a player 403, removing and placing chips in the modules 405, allowing the sensors of the modules to detect the measure of chips in the modules 407, transmitting the data to the application 409, calculating the quantity and value of the chips 411 and transmitting and displaying the value of chips 413.

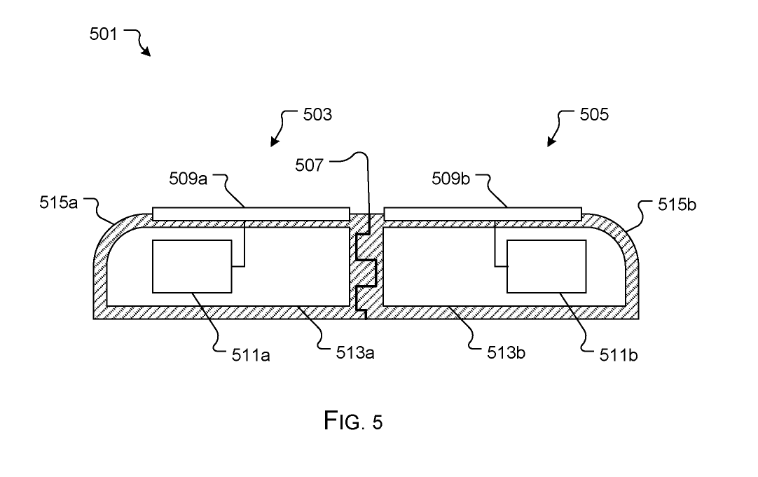

Referring now to FIG. 5 an alternative embodiment of the holding device 203 is depicted. Embodiment 501 including a first module 503, and a second module 505 temporarily attached via connector 507. Each module 503, 505 having a sensor 509 in electronic communication with a transmitter 511. The transmitters 511 are housed in a space 513 enclosed by a body 515. It will be understood that in this embodiment 501 the chips would be placed directly on sensors 509 directly and that a module would be used for a single denomination of chips.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed;:

1. A chip management system comprising:
a holding device in electronic communication with an application and display device via a network;
the holding device including at least two chip modules temporality attached via connectors;
the application being configured to receive data from the chip module and transmit the manipulated data to the display device;
wherein the chip module measures the chips placed in the module; and
wherein the application manipulates the sensor data to calculate the value of the chips;

2. The system of claim 1 wherein the chip module comprises:
a body with a trough configured to hold chips and a compartment to house a sensor and a transmitter.

3. The system of claim 1 wherein the chip module comprises:
a body with a sensor attached on the top
the sensor in electronic communication with a transmitter disposed of within a space enclosed by the body.

4. A method of managing the chips used by a game given the system of claim 1, comprising:
situating the holding device near a player;
removing and placing chips in the modules;
allowing the sensors of the modules to detect the measure of chips in the modules;
transmitting the data to the application;
calculating the quantity and value of the chips; and
transmitting and displaying the value of chips.
